(19) United States
(12) Patent Application Publication
(10) Pub. No.: US 2007/0177814 A1
(43) Pub. Date: Aug. 2, 2007

(54) Method and recording format for image compression

(75) Inventors: Guo-Zua Wu, Taichung City (TW); Yi-Jung Wang, Hsinchu City (TW); Meng-Han Tsai, Taipei City (TW); Kun-Da Wu, Nantou County (TW); Wei-Zheng Lu, Chiayi City (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: INDUSTRIAL TECHNOLOGY RESEARCH INSTITUTE, Hsinchu (TW)

(21) Appl. No.: 11/548,364

(22) Filed: Oct. 11, 2006

(30) Foreign Application Priority Data
Oct. 12, 2005 (TW) 094135448

(51) Int. Cl. G06K 9/36

(52) U.S. Cl. 382/245

(57) ABSTRACT

A method is provided for processing data of a sub-picture of a picture. The method includes: providing an object of the sub-picture, forming a binary bit map of the object, and determining whether the number of bits having a first binary value is greater than the number of bits having a second binary value in the binary bit map. The method further includes: determining whether it is necessary to transform the binary bit map into a transformed binary bit map so that the number of bits having the first binary value is smaller than the number of bits having the second binary value in the transformed binary bit map, and determining a compression rule by determining the most significant two bits of a section of consecutive bits in the binary bit map or the transformed binary bit map.

### BACKGROUND OF THE INVENTION

The present invention relates generally to method for processing image data and more particularly, to a method and a recording format for run-length compression of sub-picture information of an image.

As digital processing technology continues to evolve, the compression efficiency of audio and video data has been greatly enhanced in recent years. For example, compression formats of the Motion Picture Experts Group (“MPEG”) standards have evolved from MPEG 1 to MPEG 4. However, the compression efficiency of sub-picture data, which play an important role in the presentation of an multi-media program, has not been improved. Furthermore, the data sizes of sub-picture images increase as the demands for multi-media programs of higher definitions increase. The compression efficiency provided by conventional compression methods may be insufficient for processing high-definition multi-media programs. An example of the conventional compression methods includes the technique described in U.S. Pat. No. 6,009,202 to Kikuchi et al., entitled “Image Information Encoding/Decoding System.” Kikuchi discloses an encoding method for sub-picture data, which includes compression rules 1 to 6 with respect to FIGS. 5A to 5F thereof, and compression rules 11 to 15 with respect to FIGS. 6A to 6E thereof. These compression rules may require a large overhead of data recording, and the data format is not adjustable for better processing various content features of the sub-picture data.

It may desirable to have a method that provides the compression efficiency of sub-picture data and capable of handling high-definition video discs. It may also be desirable to have a method capable of data compression that provides adequate compression ratio and/or the flexibility in compressing sub-picture data according to the content features thereof.

### BRIEF SUMMARY OF THE INVENTION

Examples of the invention may provide a method for processing data of a sub-picture of a picture. The method may include: providing an object of the sub-picture, forming a binary bit map of the object, determining whether the number of bits having a first binary value is greater than the number of bits having a second binary value in the binary bit map, determining whether it is necessary to transform the binary bit map into a transformed binary bit map so that the number of bits having the first binary value is smaller than the number of bits having the second binary value in the transformed binary bit map, and determining a compression rule by determining the most significant two bits of a section of consecutive bits in the binary bit map or the transformed binary bit map.

Examples of the invention may also provide a another method for processing data of a sub-picture of a picture. The method may include: providing an object of the sub-picture, forming a binary bit map of the object, determining the most significant two bits of a section of consecutive bits in the binary bit map, compressing the section in a first format if the most significant bit having a first binary value is followed by the second most significant bit having a second binary value, recording the number (n1) of consecutive bits having the second binary value that follow the most significant bit in N1 bits, wherein N1 is the smallest integer that satisfies n1≦2^{N1}−1, compressing the section in a second format if the most significant bit having the first binary value is followed by the second most significant bit having the first binary value, and recording the number (n2) of consecutive bits having the first binary value that follow the most significant bit in N2 bits, wherein N2 is the smallest integer that satisfies n2≦2^{N2}−1.

Some examples of the invention may also provide a method capable of data compression and decompression for a sub-picture of a picture that comprises determining an object of the sub-picture, forming a binary bit map of the object, determining a compression rule capable of compressing a section of consecutive bits in the binary bit map by determining the most significant two bits of the section, compressing the section of consecutive bits in accordance with the compression rule to form a compressed section, and recording a parameter corresponding to the compression rule in a data format, wherein the parameter determines a length of the compressed section.

Examples of the invention may also provide a data format capable of recording compression information for an object of a sub-picture that comprises a first field capable of recording a parameter corresponding to a compression rule for compressing a section of consecutive bits in a binary bit map of the object, and a second field capable of recording a compressed section formed by compressing the section of consecutive bits in accordance with the compression rule, wherein the parameter determines a length of the compressed section.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings examples consistent with the invention. It should be understood, however, that the invention is not limited to the precise arrangements and instrumentalities shown.

In the drawings:

FIG. 1A is a schematic diagram of a picture including a sub-picture;

FIGS. 1B and 1C are schematic diagrams of objects of a sub-picture consistent with examples of the present invention;

FIG. 2A is a schematic diagram of a structure of a picture consistent with an example of the present invention;

FIG. 2B is a schematic diagram of a structure of a picture head illustrated in FIG. 2A;

FIG. 2C is a schematic diagram of a structure of an object illustrated in FIG. 2A;

FIG. 3A is a bit map of an object consistent with an example of the present invention;

FIG. 3B is a transformed bit map of the object illustrated in FIG. 3A consistent with an example of the present invention;

FIG. 3C is a transformed bit map of the object illustrated in FIG. 3A consistent with another example of the present invention;

FIG. 4 is a flow chart illustrating a method of compression consistent with an example of the present invention;

FIGS. 5A to 5D are flow charts illustrating methods of compression consistent with examples of the present invention;

FIGS. 6A to 6D are schematic diagrams of recording formats consistent with examples of the present invention;

FIGS. 7A to 7H are schematic diagrams illustrating a method of compression consistent with another example of the present invention;

FIG. 8A is a schematic diagram of a bit stream after compression;

FIG. 8B is a flow chart illustrating a method of decompression consistent with an example of the present invention;

FIG. 9A is a plot illustrating experimental results of the English alphabet;

FIG. 9B is a plot illustrating experimental results of a set of Chinese characters; and

FIG. 10 is a block diagram illustrating a method of compression consistent with an example of the present invention.

### DETAILED DESCRIPTION OF THE INVENTION

Reference will now be made in detail to the present embodiments of the invention, examples of which are illustrated in the accompanying drawings. Wherever possible, the same reference numbers will be used throughout the drawings to refer to the same or like portions.

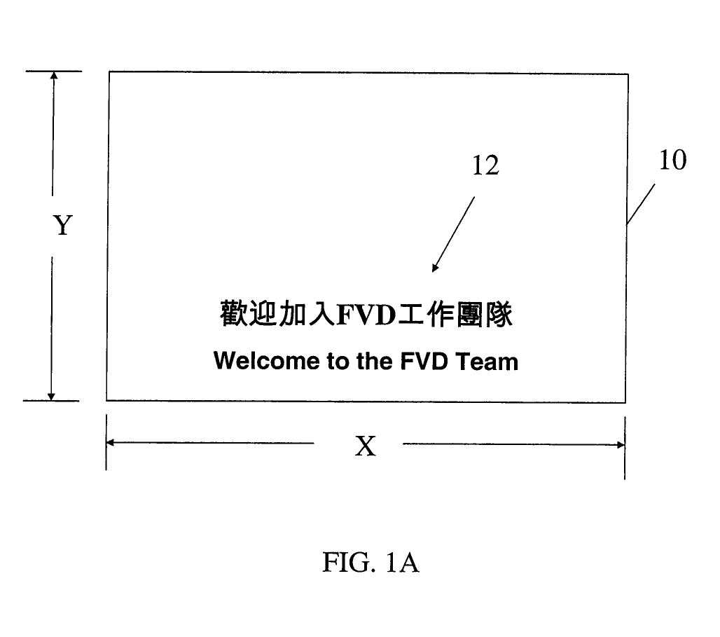

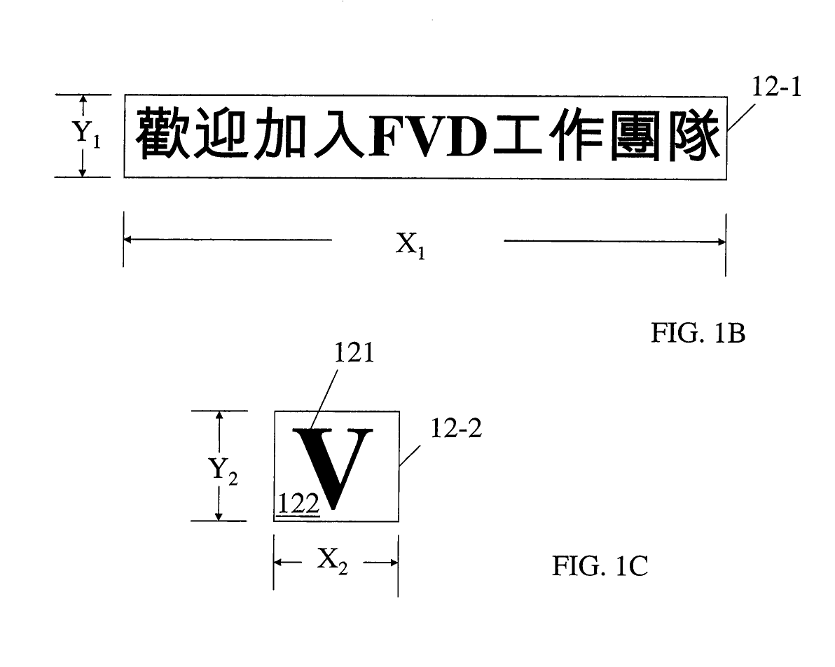

FIG. 1A is a schematic diagram of a picture 10 including a sub-picture 12. Referring to FIG. 1A, the picture 10, which refers to a main image of a movie, has a two-dimensional size of X (pixels) by Y (pixels). The sub-picture 12, which refers to subtitles or text data displayed on the picture 10 in the movie, may include multi-language texts, such as texts in English and Chinese. In the present example, the first line of the sub-picture 12 includes eight Chinese characters and 3 English characters, which is the Chinese version of the “Welcome to the FVD Team” in the second line. In some examples, the sub-picture may include only one line of texts or multiple lines of texts in the same language or different languages.

FIGS. 1B and 1C are schematic diagrams of objects of a sub-picture consistent with examples of the present invention by using the first line in FIG. 1A as an example. A sub-picture includes at least one object. Referring to FIG. 1B, the characters in the sub-picture 12 illustrated in FIG. 1A as a whole are taken as an object 12-1. As a result, the object 12-1 has a same size as the sub-picture 12, i.e., X₁ by Y₁. Referring to FIG. 1C, each of the characters in the sub-picture 12 is taken as an object 12-2. Each of the objects 12-2 has a same size of X₂ by Y₂, and includes a text portion 121 and a background portion 122. Various object sizes may be used for various applications.

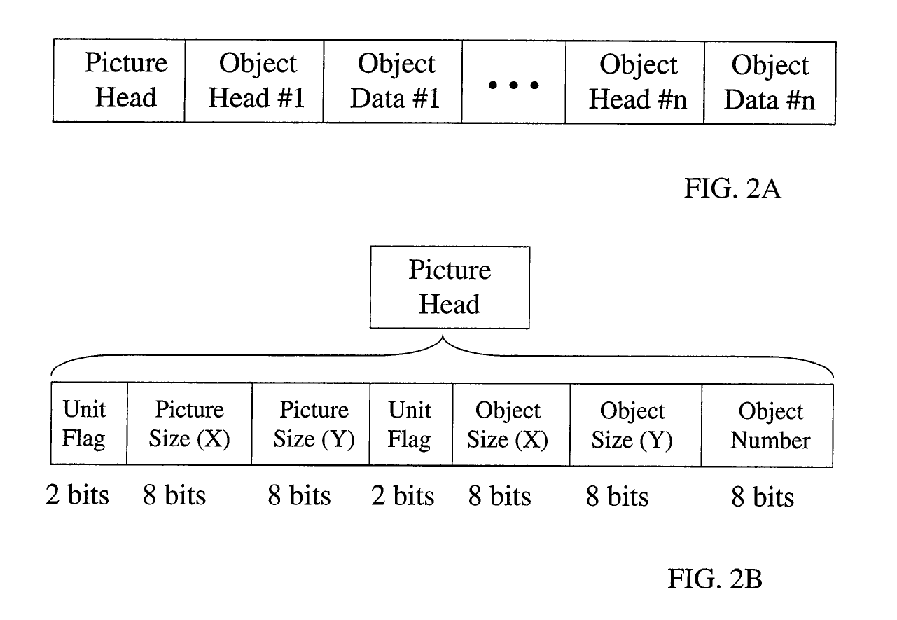

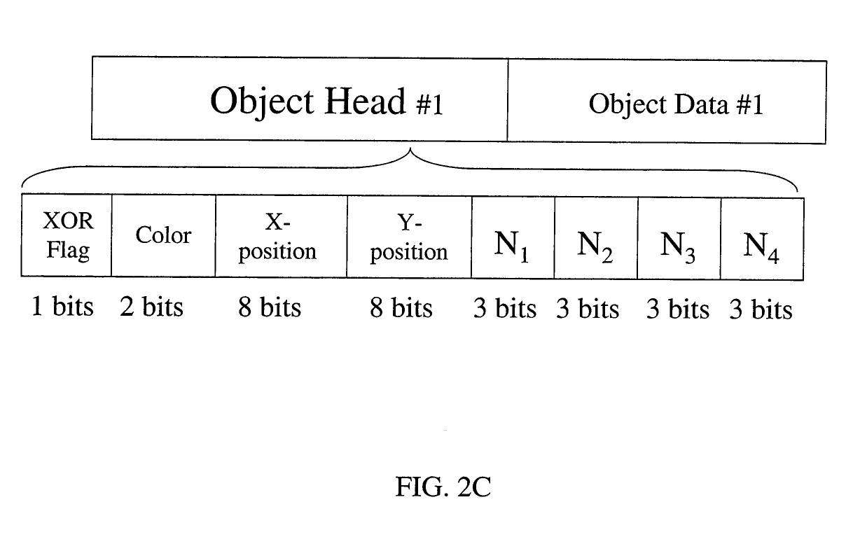

FIG. 2A is a schematic diagram of a structure of a picture consistent with an example of the present invention. Referring to FIG. 2A, the structure of a picture includes a picture head followed by a plurality of object structures. In the present example, a total number of “n” object structures are provided subsequent to the picture head. Each of the object structures includes an object head and an object data unit immediately after the object head. Parameters and compressed data collected during a compression process are stored in the object head and the object data unit, respectively.

FIG. 2B is a schematic diagram of a structure of a picture head illustrated in FIG. 2A. Referring to FIG. 2B, the structure of the picture head specifies the unit size, for example, one pixel or four pixels, in a unit flag, the picture size, the object size and the number of objects in the picture.

FIG. 2C is a schematic diagram of a structure of an object illustrated in FIG. 2A. Referring to FIG. 2C, the structure of an object includes an object head followed by an object data unit. The object head includes an exclusive-OR (XOR) flag, a color field and object size information fields. The XOR flag is used to specify whether an exclusive-or operation is performed, which will be further discussed in detail. The color field is used to specify the color information of the text portion of an object relative to the background portion. In one example consistent with the present invention, a binary value “1” is assigned to pixels of the text portion, while a binary value “0” is assigned to pixels of the background portion as the color field is set to “1”. The object head further includes compression information in parameters N1, N2, N3 and N4, which record length values of the data stored in the object data unit in accordance with corresponding compression rules. The compression rules and the parameters N1, N2, N3 and N4 will be further discussed in detail.

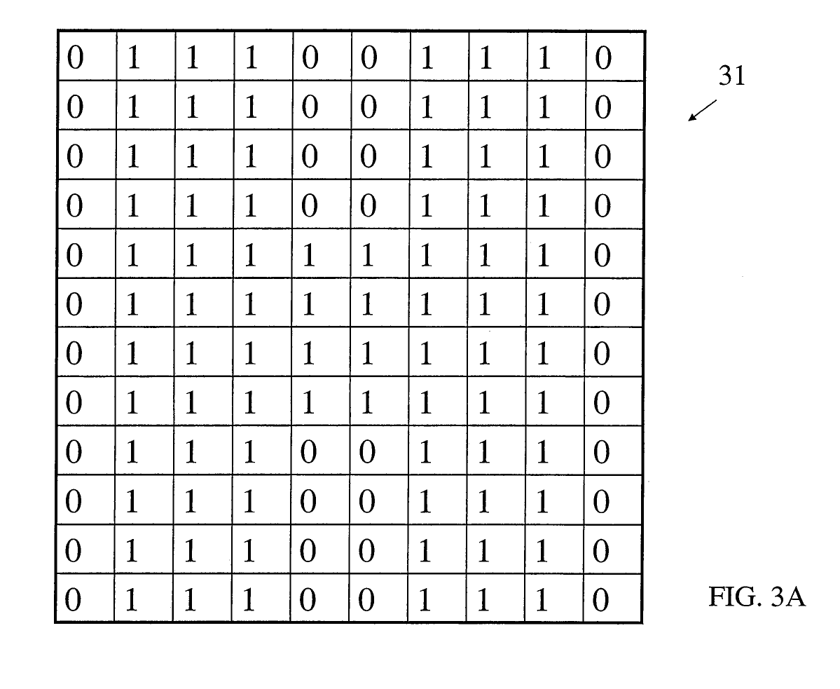

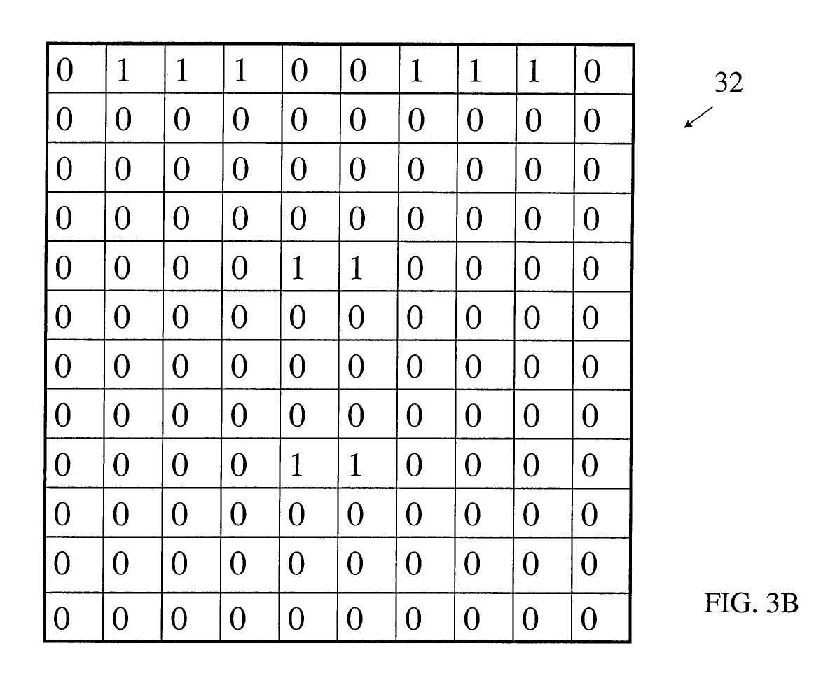

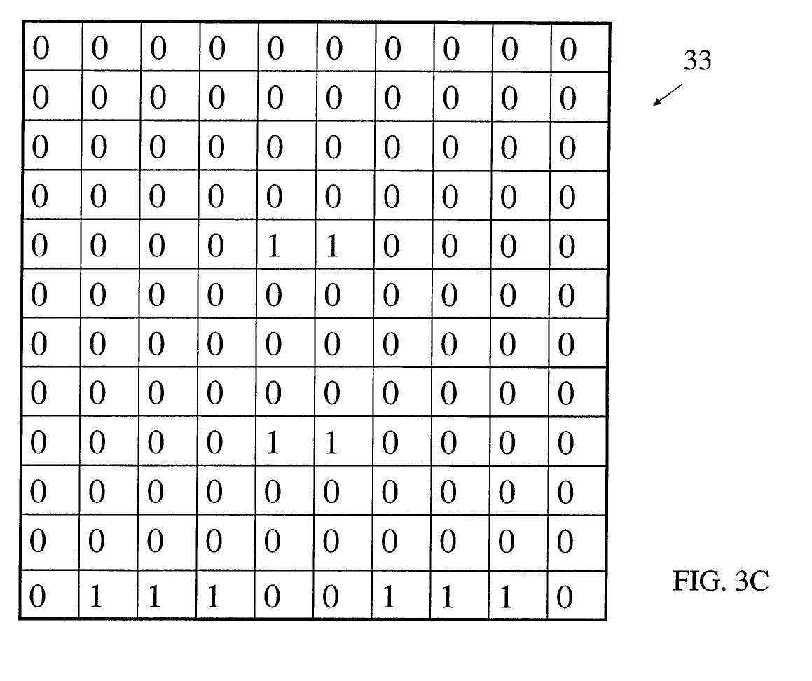

FIG. 3A is a bit map 31 of an object consistent with an example of the present invention. Referring to FIG. 3A, an object having a text portion in the form of “H” is scanned. Given that the color field is set to 1, the binary value “1” is assigned to pixels of the text portion, while the binary value “0” is assigned to pixels of the background. To facilitate compression, the number of the binary value “1” may be smaller than that of the binary value “0” when the color field is set to “1”, or vice versa. Furthermore, to reduce the number of the binary value “1” if the binary value “0” is outnumbered, in one example consistent with the present invention, an exclusive-or (XOR) operation may be performed. The XOR operation may be performed row-by-row from a top row (downward XOR) or a bottom row (upward XOR), or column-by-column from a left column (rightward XOR) or a right column (leftward XOR). An XOR operation refers to a logical operation on two operands that results in a logical value of “true” if and only if one of the operands, but not both, has a value of “true”.

FIG. 3B is a transformed bit map 32 of the object illustrated in FIG. 3A consistent with an example of the present invention. Referring to FIGS. 3A and 3B, when the downward XOR is performed, the first row of the bit map 31 serves as the first row of the transformed bit map 32. The first row and the second row of the bit map 31 are XORed to one another, in which the first entry of the first row of the bit map 31 is XORed with the first entry of the second row of the bit map 31, the second entry of the first row of the bit map 31 is XORed with the second entry of the second row of the bit map 31, and so forth. The result of the XOR operation may be written to the second row of the transformed bit map 32. In a downward XOR operation, the first row of the bit map 31 illustrated in FIG. 3A may be written to the first row of the bit map 32, and the result of an XOR operation by an n-th row and an (n+1)-th row of the bit map 31 is written to the (n+1)-th row of the transformed bit map 32. After the XOR operation, the number of the binary value “1” is smaller than that of the binary value “0” in the transformed bit map 32.

FIG. 3C is a transformed bit map 33 of the object illustrated in FIG. 3A consistent with another example of the present invention. Referring to FIG. 3C, the bit map 33 is a result of an upward XOR operation performed upon the bit map 31 illustrated in FIG. 3A. In an upward XOR operation, the last row of the bit map 31 illustrated in FIG. 3A is written to the first row of the bit map 33, and the result of an XOR operation by an (n+1)-th row and an n-th row of the bit map 31 is written to the n-th row of the transformed bit map 32. The XOR operations illustrated with respect to FIGS. 3B and 3C are exemplary only. Therefore, other methods may be applied to transform a bit map having a greater number of binary “1” into one having a greater number of binary “0.”. For instance, in one example, an inversion operation may performed to transform the binary “1” into “0”, and vice versa, so that the number of binary “1” is smaller than that of the binary “0” in a transformed bit map.

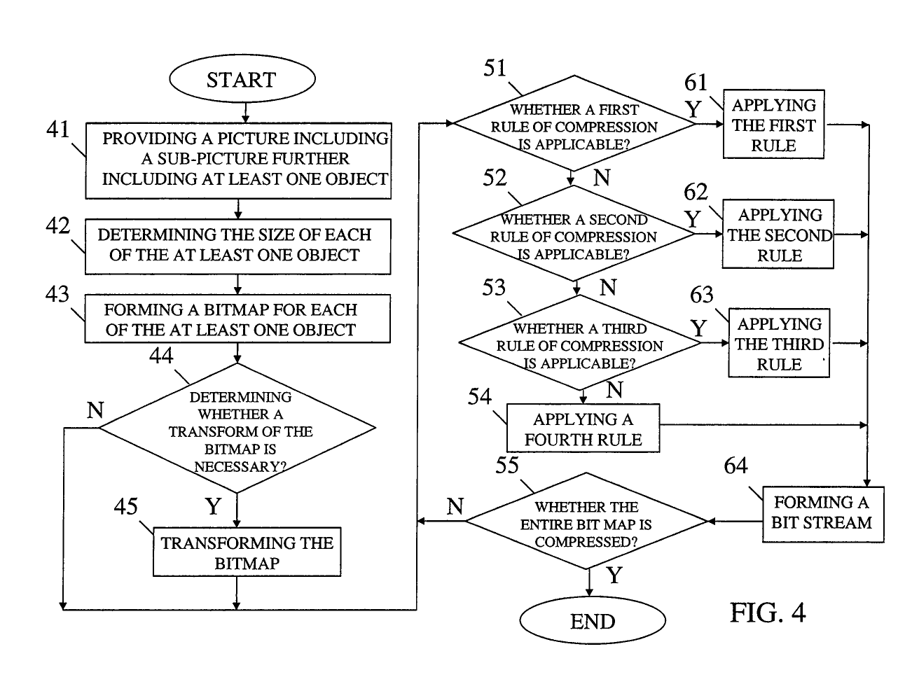

FIG. 4 is a flow chart illustrating a method of compression consistent with an example of the present invention. Referring to FIG. 4, at step 41, a picture including a sub-picture is provided. The sub-picture includes at least one object. At step 42, the size of each of the at least one object is determined. Next, at step 43, a bit map for each of the at least one object is formed by assigning a first binary value and a second binary value to pixels of a text portion and a background portion of each of the least one object, respectively. Next, at step 44, it is determined whether a transform of the bit map is required. If the number of the binary value “1” is greater than that of the binary value “0”, given that the color field is set to “1”, an XOR operation is performed at step 45 to obtain a transformed bit map. The steps 44 and 45, however, are optional. That is, the process of compression may continue without performing any transform even though the number of pixels having the value “1” is greater.

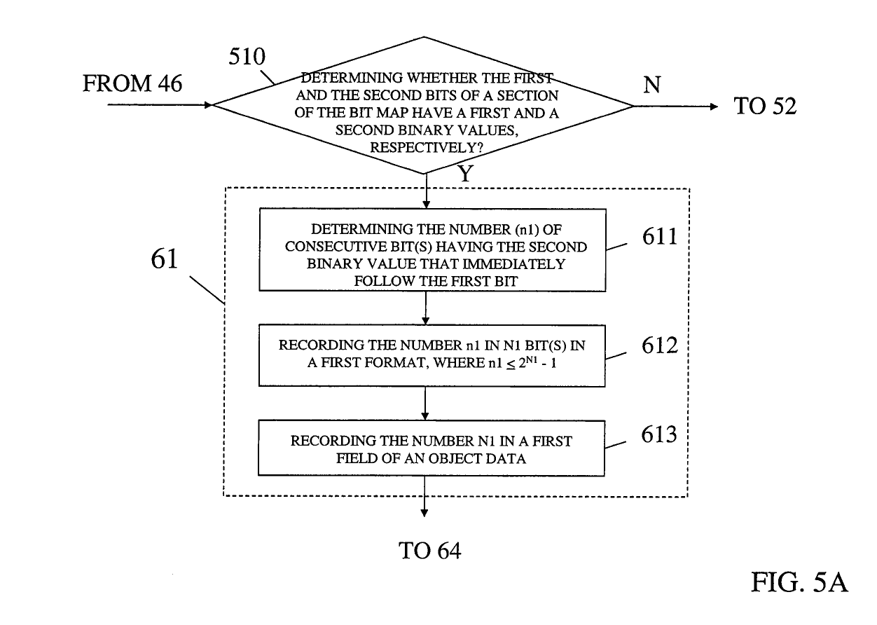

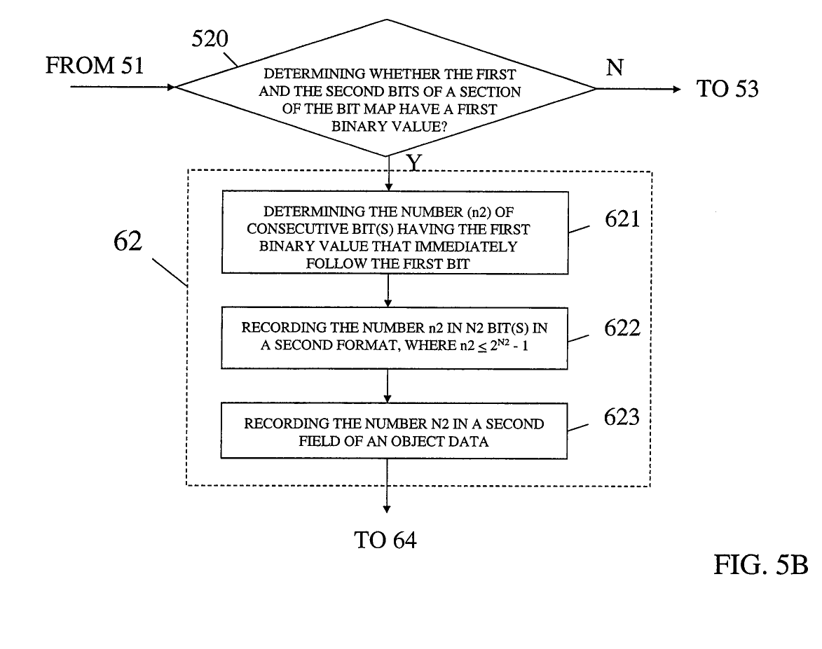

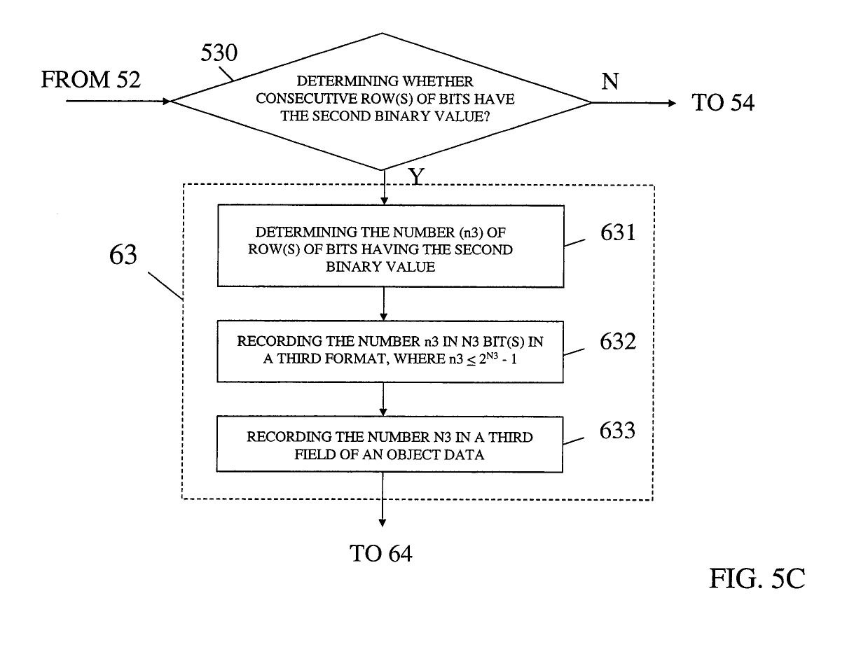

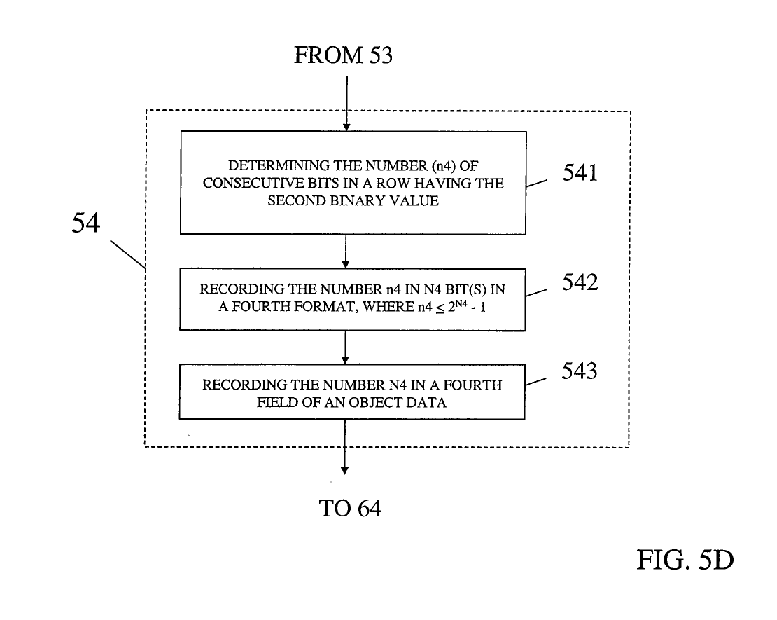

Next, it is determined whether a first, a second, a third or a fourth compression rule is applicable to the leading section of a bit map. Once one of the compression rules is determined, it is then determined whether one of the compression rules is applicable to the leading section of the remaining of the bit map. Such a compression process continues until the bit map is compressed into a bit stream. The leading section may include a continuous portion of a row or several continuous rows of the bit map. Specifically, at step 51, it is determined whether a first rule of compression is applicable to the leading section of the bit map, either transformed or not transformed. If confirmative, the first rule is applied at step 61, which will be discussed with respect to FIG. 5A. If not, at step 52, it is determined whether a second rule of compression is applicable to the leading section. If confirmative, the second rule is applied at step 62, which will be discussed with respect to FIG. 5B. If not, at step 53, it is determined whether a third rule of compression is applicable to the section. If confirmative, the third rule is applied at step 63, which will be discussed with respect to FIG. 5C. If not, a fourth rule of compression is applied at step 54, which will be discussed with respect to FIG. 5D. The outputs from steps 61, 62, 63 and 54 are collected in a bit stream at step 64. The process continues to determine whether one of the first, second, third and fourth rules of compression is applicable to subsequent sections of the bit map until all of the entire bit map is compressed.

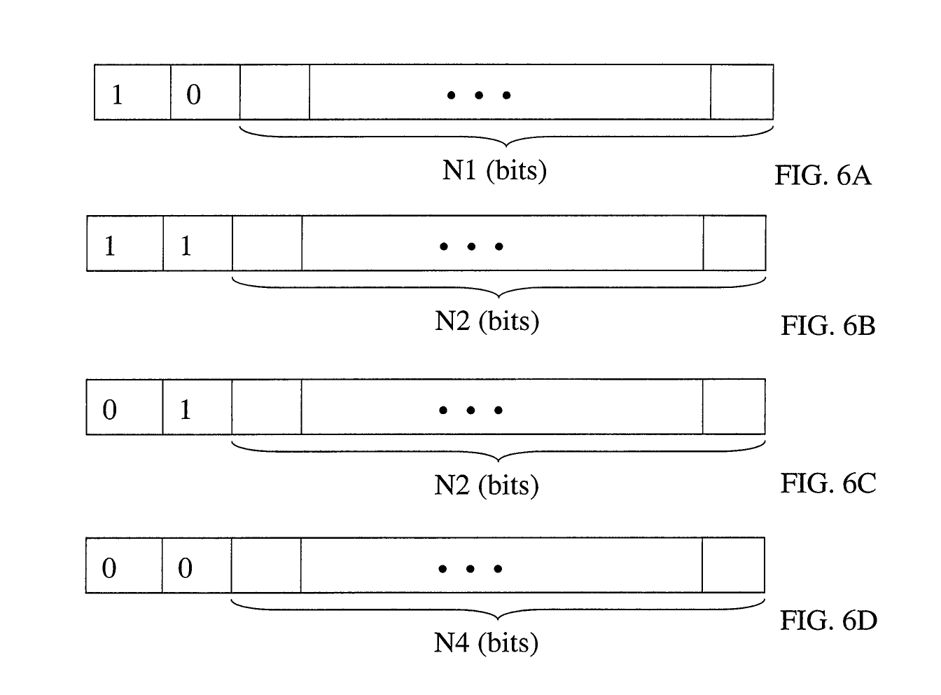

FIGS. 5A to 5D are flow charts illustrating methods of compression consistent with examples of the present invention. Referring to FIG. 5A, also referring to FIG. 4, at step 510, it is determined whether the first two bits of a section of the bit map are “1” and “0”, given the color flag being set to “1”. If confirmative, at step 611, the number (n1) of consecutive “0” that immediately follow the first bit “1” is counted. Next, at step 612, the number n1 is recorded in N1 bits in a first format illustrated in FIG. 6A. The number N1 is the smallest integer that satisfies n1≦2^{N1}−1. Next, at step 613, the number N1 is recorded in a first field of an object head as that illustrated in FIG. 2C.

Referring to FIG. 5B, also referring to FIG. 4, at step 520, it is determined whether the first two bits of a section of the bit map are “1” and “1”. If confirmative, at step 621, the number (n2) of consecutive “1” that immediately follow the first bit “1” is counted. Next, at step 622, the number n2 is recorded in N2 bits in a second format illustrated in FIG. 6B. The number N2 is the smallest integer that satisfies n2≦2^{N2}−1. Next, at step 623, the number N2 is recorded in a second field of an object head as that illustrated in FIG. 2C.

Referring to FIG. 5C, also referring to FIG. 4, at step 530, it is determined whether there are consecutive rows of bits in the bit map having the binary value “0”. If confirmative, at step 631, the number (n3) of consecutive rows of “0” is counted. Next, at step 632, the number n3 is recorded in N3 bits in a third format illustrated in FIG. 6C. The number N3 is the smallest integer that satisfies n3≦2^{N3}−1. Next, at step 633, the number N3 is recorded in a third field of an object head as that illustrated in FIG. 2C.

Referring to FIG. 5D, also referring to FIG. 4, at step 541, the number (n4) of consecutive “0” in a row of the bit map is counted. Next, at step 542, the number n4 is recorded in N4 bits in a fourth format illustrated in FIG. 6D. The number N4 is the smallest integer that satisfies n4≦2^{N4}−1. Next, at step 543, the number N4 is recorded in a fourth field of an object head as that illustrated in FIG. 2C.

FIGS. 6A to 6D are schematic diagrams of recording formats consistent with examples of the present invention. Referring to FIG. 6A, the first two bits indicate that a number of consecutive “0” immediately follow the first bit “1”. The actual number of the consecutive “0” is specified in the following N1 bits. The (N1+2) bits as a whole are stored in an object data unit and collected in a bit stream. If more than one of the sections satisfy the first rule and hence more than one n1 (s) exists, only the value of N1 corresponding to the maximum n1 is recorded in the object head.

Referring to FIG. 6B, similarly, the first two bits indicate that a number of consecutive “1” immediately follow the first bit “1”. The actual number of the consecutive “1” is specified in the following N2 bits. The (N2+2) bits are stored in the object data unit and collected in the bit stream. If more than one of the sections satisfy the second rule and hence more than one n2(s) exists, only the value of N2 corresponding to the maximum n2 is recorded in the object head.

Referring to FIG. 6C, the first two bits indicate a number of consecutive rows of “0”. The actual number of the consecutive rows is specified in the following N3 bits. The (N3+2) bits are stored in the object data unit and collected in the bit stream. If more than one of the sections satisfy the third rule and hence more than one n3(s) exists, only the value of N3 corresponding to the maximum n3 is recorded in the object head.

Referring to FIG. 6D, the first two bits indicate that a number of consecutive “0” appear in a row but do not occupy the entire row. The actual number of the consecutive “0” is specified in the following N4 bits. The (N4+2) bits are stored in the object data unit and collected in the bit stream. If more than one of the sections satisfy the fourth rule and hence more than one n4(s) exists, only the value of N4 corresponding to the maximum n4 is recorded in the object head.

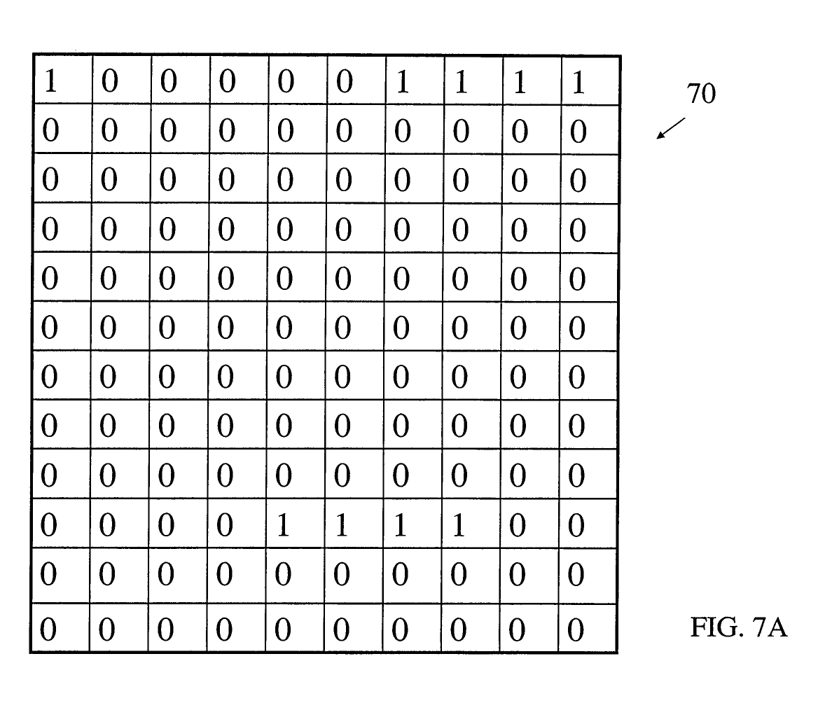

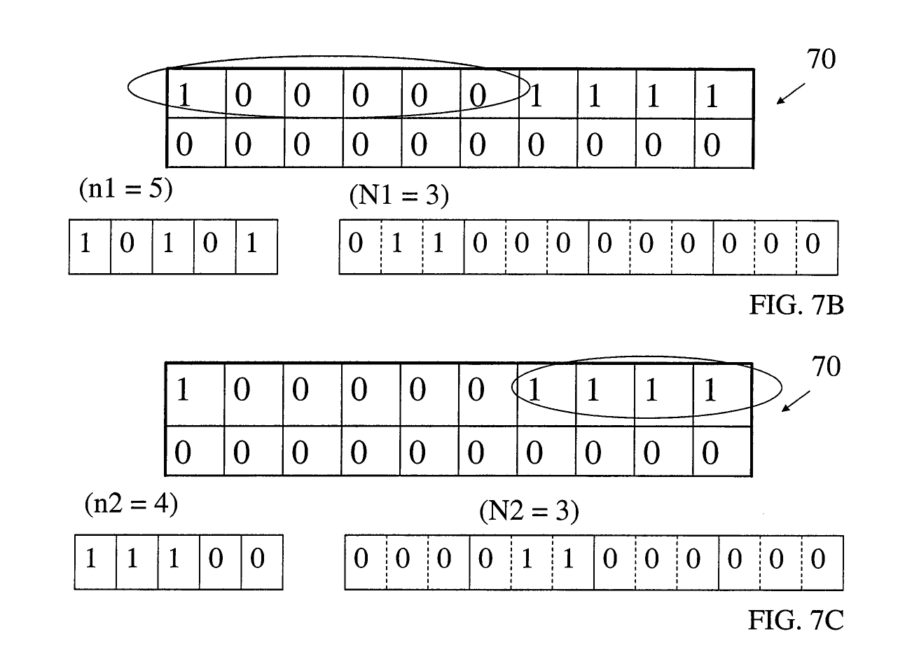

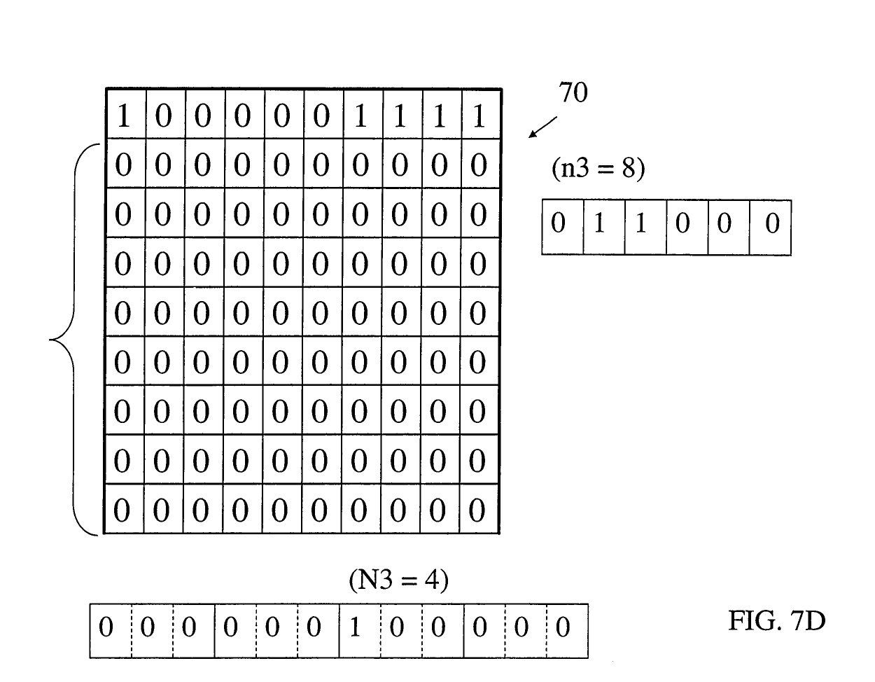

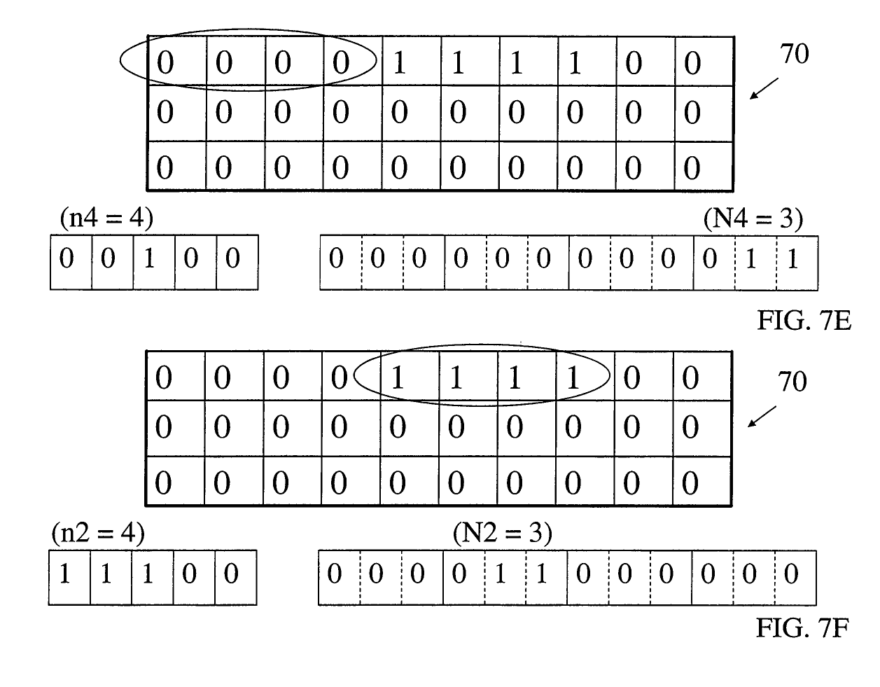

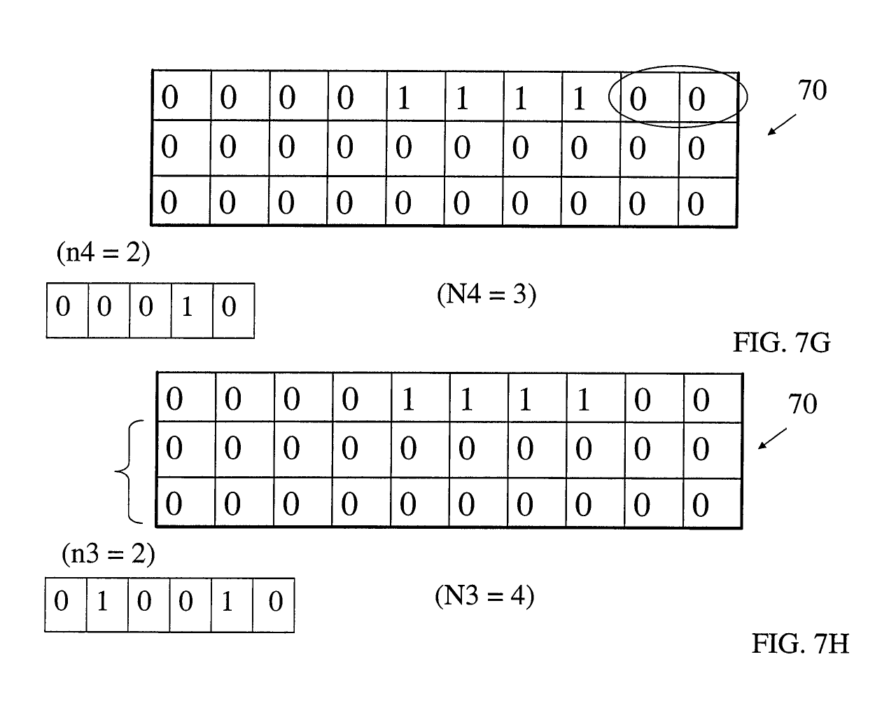

FIGS. 7A to 7H are schematic diagrams illustrating a method of compression consistent with another example of the present invention. Referring to FIG. 7A, a bit map 70 of an object to be compressed is provided. Referring to FIG. 7B, it is determined that the first rule of compression is applicable to a first section, which is the leading section, of the bit map 70. Furthermore, it is determined that the value of n1 is 5 because five consecutive “0” follow the first bit “1” in the first section. The value of N1, which equals 3, is also determined. The values of n1 and N1 are respectively recorded in a first format in an object data unit and a first field of an object head.

Referring to FIG. 7C, it is determined that the second rule of compression is applicable to a second section immediately after the first section of the bit map 70. Furthermore, it is determined that the value of n2 is 4 because four consecutive “1” follow the first bit “1” in the second section. The value of N2, which equals 3, is also determined. The values of n2 and N2 are respectively recorded in a second format and a second field of the object head.

Referring to FIG. 7D, it is determined that the third rule of compression is applicable to a third section immediately after the second section of the bit map 70. Furthermore, it is determined that the value of n3 is 8 because eight consecutive rows of “0” appear. The value of N3, which equals 4, is also determined. The values of n3 and N3 are respectively recorded in a third format and a third field of the object head.

Referring to FIG. 7E, it is determined that the fourth rule of compression is applicable to a fourth section immediately after the third section of the bit map 70. Furthermore, it is determined that the value of n4 is 4 because four consecutive “0” appear in a row in the third section. The value of N4, which equals 3, is also determined. The values of n4 and N4 are respectively recorded in a fourth format and a fourth field of the object head.

Referring to FIG. 7F, it is determined that the second rule of compression is applicable to a fifth section immediately after the fourth section of the bit map 70. Furthermore, it is determined that the value of n2 is 4 because four consecutive “1” follow the first bit “1” in the fifth section. However, since the value of n2 with respect to FIG. 7F equals that with respect to FIG. 7C, the value of n2 for the fifth section is recorded in the N2 bits in the second format.

Referring to FIG. 7G, it is determined that the fourth rule of compression is applicable to a sixth section immediately after the fifth section of the bit map 70. Furthermore, it is determined that the value of n4 is 2 because two consecutive “0” appear in a row in the sixth section. Since the value of n4 with respect to FIG. 7G is smaller than that (n4=4) with respect to FIG. 7E, the value of n4 for the sixth section is recorded in the N4 bits in the fourth format.

Referring to FIG. 7H, it is determined that the third rule of compression is applicable to a seventh section immediately after the sixth section of the bit map 70. Furthermore, it is determined that the value of n3 is 2 because two consecutive rows of “0” appear in the seventh section. Since the value of n3 with respect to FIG. 7H is smaller than that (n3=8) with respect to FIG. 7D, the value of n3 for the seventh section is recorded in the N3 bits in the third format.

The compression algorithm including the four compression rules discussed with respect to FIGS. 7A to 7H is exemplary only. In another example according to the present invention, a compression algorithm includes the compression rules as follows.

(1) Determine whether the most significant two bits of a section of consecutive bits in a bit map are a binary “1” followed by a binary “0”. If confirmative, calculate the number of consecutive bits having the binary value “0” that follow the most significant bit in the section. The recording format and compressed data associated with the rule are the same as those of the first compression rule discussed with respect to FIGS. 7A to 7H and are not discussed.

(2) Determine whether the most significant two bits of a section of consecutive bits in a bit map are a binary “1” followed by another binary “1”. If confirmative, calculate the number of consecutive bits having the binary value “1” that follow the most significant bit in the section. The recording format and compressed data associated with the rule are the same those of the second compression rule discussed with respect to FIGS. 7A to 7H and are not discussed.

(3) Determine whether the most significant two bits of a section of consecutive bits in a bit map are a binary “0” followed by a binary “1”. If confirmative, calculate the number of consecutive bits having the binary value “1” that follow the most significant bit in the section. The recording format and compressed data associated with the rule are similar to those of the first compression rule discussed with respect to FIGS. 7A to 7H and are not discussed.

(4) Determine whether the most significant two bits of a section of consecutive bits in a bit map are a binary “0” followed by another binary “0”. If confirmative, calculate the number of consecutive bits having the binary value “0” that follow the most significant bit in the section. The recording format and compressed data associated with the rule are similar to those of the first compression rule discussed with respect to FIGS. 7A to 7H and are not discussed.

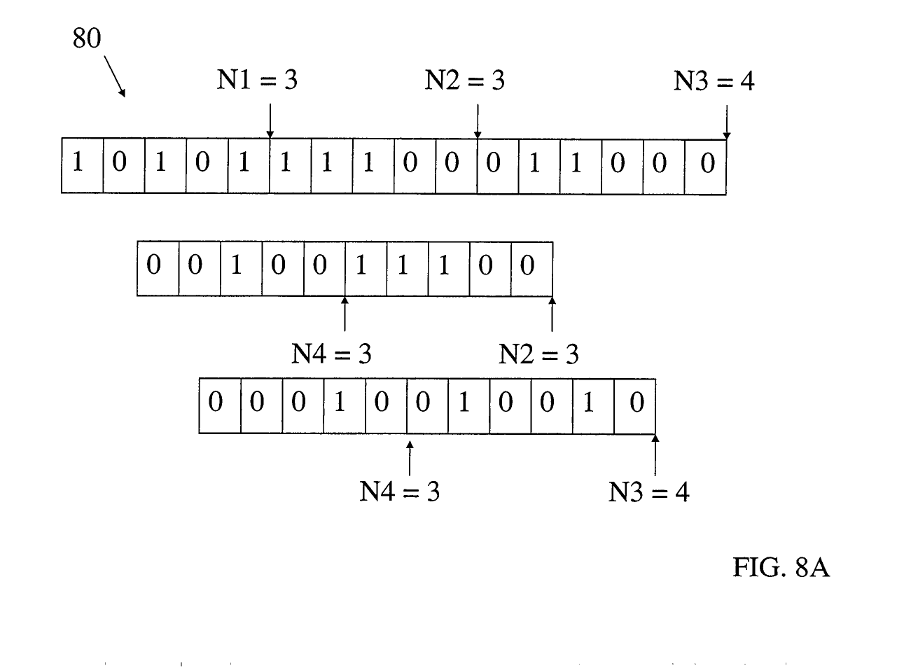

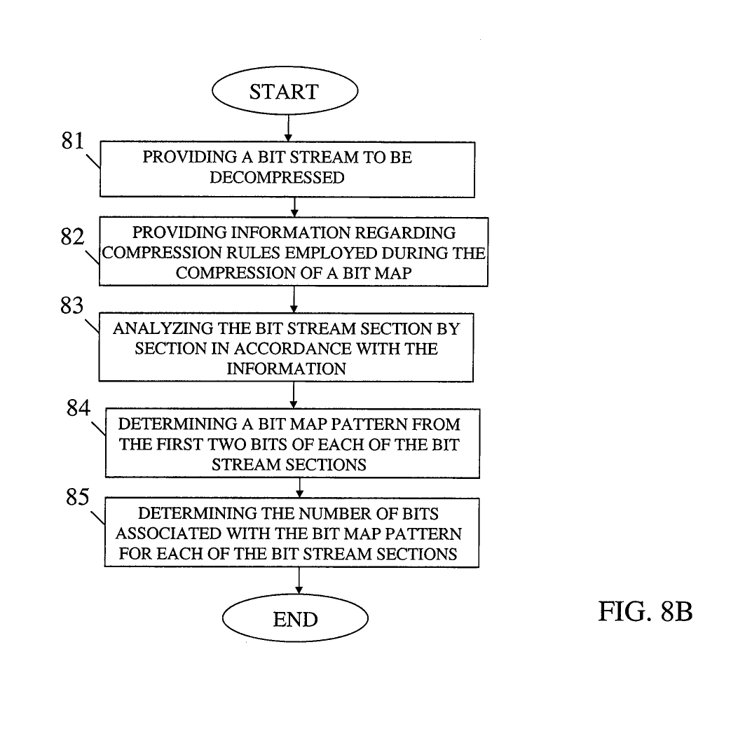

FIG. 8A is a schematic diagram of a bit stream 80 after compression. Referring to FIG. 8A, the bit stream 80 is formed by, for example, a method illustrated in FIGS. 7A to 7H. To decompress the bit stream 80, the values of n1 to n4 and N1 to N4 recorded for each section of the bit map 70 illustrated with respect to FIGS. 7B to 7H are used. The bit stream 80 includes 37 bits if one bit is taken as a unit. The compression ratio, that is, a ratio of the number of bits before compression to the number of bits after compression, is calculated below.

compression ratio=(10×12)/(37)

At the initial of the decompression, the leading section of the bit stream 80 is first considered. Since the first two bits of the bit stream 80 are “1” and “0”, which indicate that the first rule of compression was applied during the compression process, it is determined that the following N1 bits specify the number (n1) of consecutive “0” following the first bit “1”. Furthermore, since the value of N1 is 3 (three), the value of n1 is calculated from the binary value of the three bits “101” following the first two bits “10”, which equals 5 (five), resulting in a first section of a binary bit map, i.e., 100000. As a result, the length of the first section of the bit stream 80 is determined by the value of (N1+2), and the first section itself includes the information regarding a bit map compression rule (accessible by the first two bits) and the number of bits associated with the compression rule (accessible by the value of the following N1 bits). Consequently, the bit stream 80 is analyzed into sections in accordance with the values of N1, N2, N3 and N4 recorded during the compression process.

FIG. 8B is a flow chart illustrating a method of decompression consistent with an example of the present invention. Referring to FIG. 8B, a bit stream to be decompressed is provided at step 81. The bit stream, which has been compressed from a binary bit map prior to the decompression, is stored in an object data unit and is retrievable therefrom. Next, at step 82, the information regarding the compression rules collected during the compression of the bit map is provided. The information, including N1, N2, N3 and N4, has been recorded in an object head and is retrievable therefrom. At step 83, the bit stream is analyzed section by section from the leading section in accordance with the information. At step 84, a bit map pattern is determined by the first two bits of each of the bit stream sections. Next, at step 85, the number of bits associated with the bit map pattern is determined. A binary bit map is then formed when each of the bit stream sections is decompressed. Subsequently, an object corresponding to the bit map is decoded.

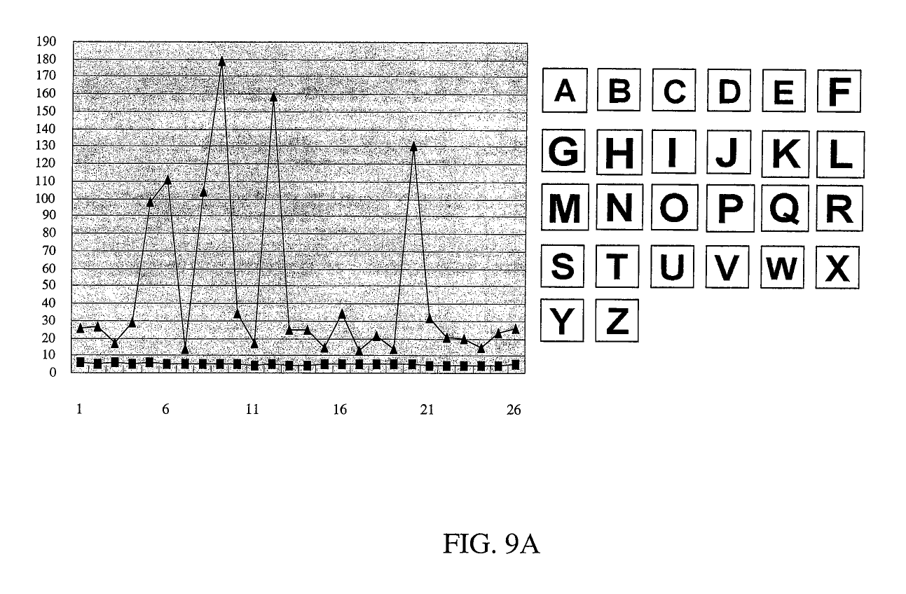

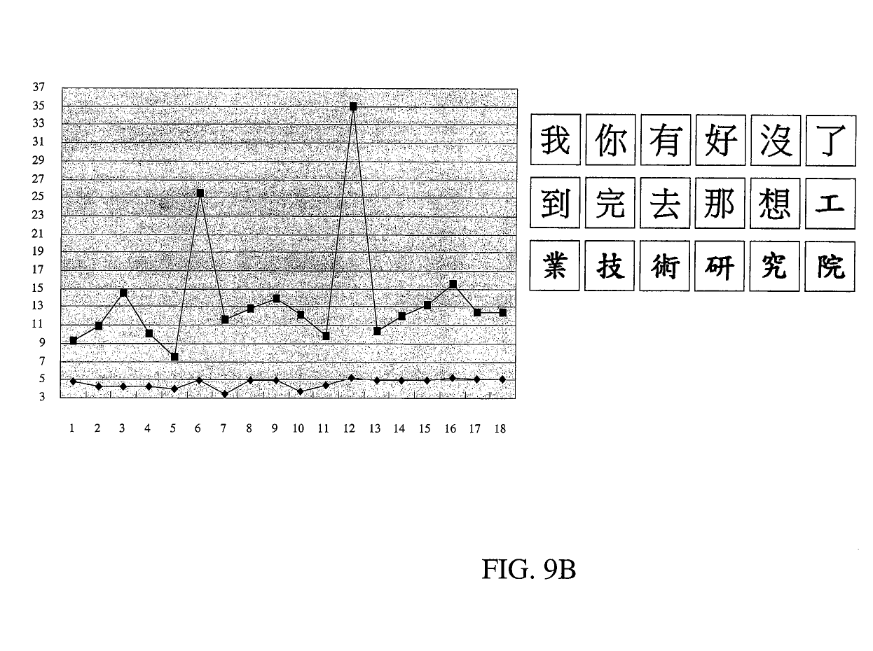

FIG. 9A is a plot illustrating experimental results of the English alphabet. Referring to FIG. 9A, by implementing a method consistent with the present invention to the English alphabet from A to Z, it is found that the character “I” has the greatest compression ratio, approximately 180, mainly due to its relatively high symmetry and simplicity in form. Characters such as “G”, “Q” and “S” have relatively small compression ratio due to their low symmetry or complexity in form.

FIG. 9B is a plot illustrating experimental results of using a set of Chinese characters. Referring to FIG. 9B, the right-most character of the second line (which literally means “work”) has a relatively high compression ratio due to its symmetry and simplicity. Averagely, a Chinese character, which may include curves, bends and turns that add complexity to its form, has a lower compression ratio than an English character.

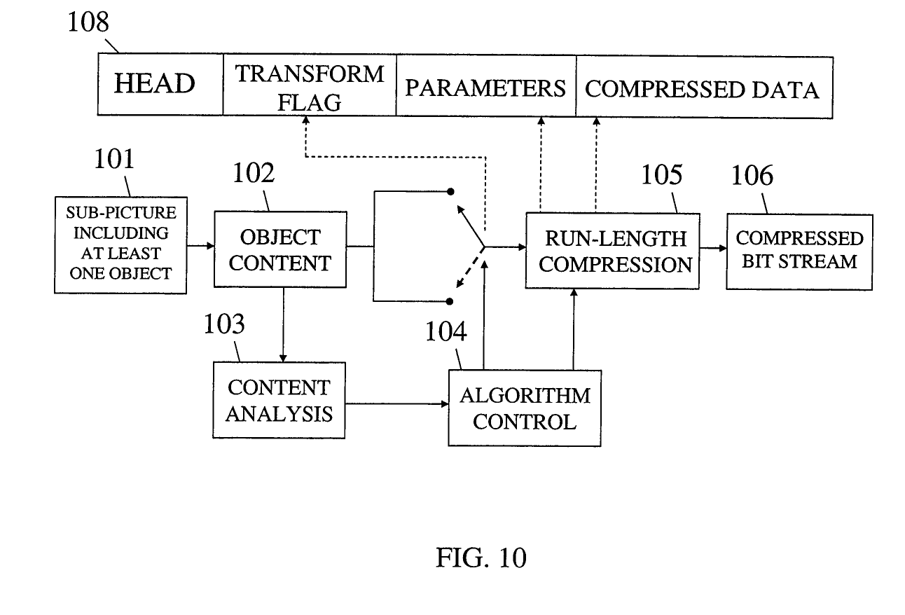

FIG. 10 is a block diagram illustrating a method of compression consistent with an example of the present invention. Referring to FIG. 10, a sub-picture including at least one object is provided at step 101. Next, a bit map of the object is formed at step 102. At step 103, the content of the object, which includes binary bits “1” and “0”, is analyzed to determine whether a transform of the bit map may facilitate the compression. In one example according to the present invention, if the number of the binary bits “1” is greater than that of the binary bits “0” in the bit map, an exclusive-or (XOR) operation is performed line by line to the bit map. In another example, an inversion operation is performed bit by bit to the bit map. The transform of the bit map, either by the XOR operation, the inversion operation or other suitable operation, results in a transformed bit map including a greater number of the binary “0”. If a transformed is performed, a binary “1”, for example, is written to a transform flag of a recording format 108. On the contrary, if no transformed is performed, a binary “0”is written to the transform flag.

Next, at step 104, an algorithm for compressing the bit map is selected. Selection of a suitable algorithm may depend on the content of a bit map. For example, if a bit map includes several rows of binary “0”, an algorithm including compression rules similar to those described with respect to FIGS. 7A to 7H is used for the compression. In another example, an algorithm including compression rules based on the four patterns of the most significant two bits, which has been previously discussed, is used for the compression. Next, a run-length compression of the bit map, either transformed or not, is performed in accordance with the compression algorithm selected at step 105. Parameters and compressed data obtained during the compression compress are recorded in the recording format 108. Subsequently, a compressed bit stream is obtained at step 106 by connecting the recorded compressed data.

It will be appreciated by those skilled in the art that changes could be made to one or more of the examples described above without departing from the broad inventive concept thereof. It is understood, therefore, that this invention is not limited to the particular examples disclosed, but it is intended to cover modifications within the scope of the present invention as defined by the appended claims.

Further, in describing certain illustrative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. A method for processing data of a sub-picture of a picture, comprising:
providing an object of the sub-picture;
forming a binary bit map of the object;
determining whether the number of bits having a first binary value is greater than the number of bits having a second binary value in the binary bit map;
determining whether it is necessary to transform the binary bit map into a transformed binary bit map so that the number of bits having the first binary value is smaller than the number of bits having the second binary value in the transformed binary bit map; and
determining a compression rule by determining the most significant two bits of a section of consecutive bits in the binary bit map or the transformed binary bit map.

2. The method of claim 1, further comprising:
performing an exclusive-or operation between every two consecutive rows of the binary bit map.

3. The method of claim 1, further comprising:
performing an inversion operation to determine a complementary value for each bit of the binary bit map.

4. The method of claim 1, further comprising:
specifying in a field of a recording form whether a transform of the binary bit map is performed.

5. The method of claim 1, further comprising:
applying a first compression rule as the most significant two bits are one first binary value followed by one second binary value; and
calculating the number of consecutive bits having the second binary value that follow the most significant bit.

6. The method of claim 5, further comprising:
recording the number (n1) of the consecutive bits having the second binary value that follow the most significant bit in N1 bits, wherein N1 is the smallest integer that satisfies n1≦2^{N1}−1.

7. The method of claim 6, further comprising:
recording the section of the binary bit map in a first format in (N1+2) bits, wherein the most significant bit of the first format has the first binary value, the second most significant bit of the first format has the second binary value, and the least significant N1 bits have a value equal to n1.

8. The method of claim 1, further comprising:
applying a second compression rule as the most significant two bits are one first binary value followed by another first binary value; and
calculating the number of consecutive bits having the first binary value that follow the most significant bit.

9. The method of claim 8, further comprising:
recording the number (n2) of the consecutive bits having the first binary value that follow the most significant bit in N2 bits, wherein N2 is the smallest integer that satisfies n1≦2^{N2}−1.

10. The method of claim 9, further comprising:
recording the section of the binary bit map in a second format in (N2+2) bits, wherein the most significant bit of the second format has the first binary value, the second most significant bit of the second format has the first binary value, and the least significant N2 bits have a value equal to n2.

11. The method of claim 1, further comprising:
applying a third compression rule as the most significant two bits are one second binary value followed by one first binary value; and
calculating the number of consecutive bits having the first binary value that follow the most significant bit.

12. The method of claim 11, further comprising:
recording the number (n3) of the consecutive bits having the first binary value that follow the most significant bit in N3 bits, wherein N3 is the smallest integer that satisfies n1≦2^{N3}−1.

13. The method of claim 12, further comprising:
recording the section of the binary bit map in a third format in (N3+2) bits, wherein the most significant bit of the third format has the second binary value, the second most significant bit of the third format has the first binary value, and the least significant N3 bits have a value equal to n3.

14. The method of claim 1, further comprising:
applying a fourth compression rule as the most significant two bits are one second binary value followed by another second binary value; and
calculating the number of consecutive bits having the second binary value that follow the most significant bit.

15. The method of claim 14, further comprising:
recording the number (n4) of the consecutive bits having the second binary value that follow the most significant bit in N4 bits, wherein N4 is the smallest integer that satisfies n1≦2^{N4}−1.

16. The method of claim 15, further comprising:
recording the section of the binary bit map in a fourth format in (N4+2) bits, wherein the most significant bit of the fourth format has the second binary value, the second most significant bit of the fourth format has the second binary value, and the least significant N4 bits have a value equal to n4.

17. The method of claim 17, further comprising:
applying a third compression rule as the most significant two bits are one second binary value followed by another second binary value; and
calculating the number of consecutive rows of bits having the second binary value that follow the most significant bit.

18. The method of claim 17, further comprising:
recording the number (n3) of the consecutive rows of bits having the second binary value that follow the most significant bit in N3 bits, wherein N3 is the smallest integer that satisfies n3 ≦2^{N3}−1.

19. The method of claim 18, further comprising:
recording the section of the binary bit map in a third format in (N3+2) bits, wherein the most significant bit of the third format has the second binary value, the second most significant bit of the third format has the first binary value, and the least significant N3 bits have a value equal to n3.

20. The method of claim 1, further comprising:
applying a third compression rule as the most significant two bits are one second binary value followed by another second binary value; and
calculating the number of consecutive bits that follow the most significant bit in a row of the bit map having the second binary value.

21. The method of claim 20, further comprising:
recording the number (n4) of the consecutive bits that follow the most significant bit in a row of the bit map having the second binary value in N4 bits if the most significant bit, wherein N4 is the smallest integer that satisfies n4≦2^{N4}−1.

22. The method of claim 21, further comprising:
recording the section of the binary bit map in a fourth format in (N4+2) bits, wherein the most significant bit of the first format has the second binary value, the second most significant bit of the first format has the second binary value, and the least significant N4 bits have a value equal to n4.

23. A method for processing data of a sub-picture of a picture, comprising:
providing an object of the sub-picture;
forming a binary bit map of the object;
determining the most significant two bits of a section of consecutive bits in the binary bit map;
compressing the section in a first format if the most significant bit having a first binary value is followed by the second most significant bit having a second binary value;
recording the number (n1) of consecutive bits having the second binary value that follow the most significant bit in N1 bits, wherein N1 is the smallest integer that satisfies n1≦2^{N1}−1;
compressing the section in a second format if the most significant bit having the first binary value is followed by the second most significant bit having the first binary value; and
recording the number (n2) of consecutive bits having the first binary value that follow the most significant bit in N2 bits, wherein N2 is the smallest integer that satisfies n2≦2^{N2}−1.

24. The method of claim 23, further comprising:
determining whether the number of bits having a first binary value is greater than the number of bits having a second binary value in the binary bit map; and
transforming the binary bit map so that the number of bits having the first binary value is smaller than the number of bits having the second binary value.

25. The method of claim 24, further comprising:
performing an exclusive-or operation for an m-th row and an (m+1)-th row of the binary bit map, m being a natural number; and
writing the result of the exclusive-or operation to an (m+1)-th row of another binary bit map.

26. The method of claim 1, further comprising:
specifying in a field of a recording form whether a transform of the binary bit map is performed.

27. The method of claim 23, further comprising:
compressing the section in a third format if the most significant bit having a second binary value is followed by the second most significant bit having a first binary value; and
recording the number (n3) of consecutive bits having the first binary value that follow the most significant bit in N3 bits, wherein N3 is the smallest integer that satisfies n3≦2^{N3}−1.

28. The method of claim 23, further comprising:
compressing the section in a fourth format if the most significant bit having a second binary value is followed by the second most significant bit having the second binary value; and
recording the number (n4) of consecutive bits having the second binary value that follow the most significant bit in N4 bits, wherein N4 is the smallest integer that satisfies n4≦2^{N4}−1.

29. The method of claim 23, further comprising:
compressing the section in a third format if the most significant bit having a second binary value is followed by consecutive rows of bits having the second binary value; and
recording the number (n3) of consecutive rows of bits having the second binary value that follow the most significant bit in N3 bits, wherein N3 is the smallest integer that satisfies n3≦2^{N3}−1.

30. The method of claim 23, further comprising:
compressing the section in a fourth format if the most significant bit having a second binary value is followed by consecutive bits in a row of the binary bit map having the second binary value; and
recording the number (n4) of the consecutive bits that follow the most significant bit in a row of the binary bit map having the second binary value in N4, wherein N4 is the smallest integer that satisfies n4≦2^{N4}−1.

31. A method capable of data compression and decompression for a sub-picture of a picture, comprising:
determining an object of the sub-picture;
forming a binary bit map of the object;
determining a compression rule capable of compressing a section of consecutive bits in the binary bit map by determining the most significant two bits of the section;
compressing the section of consecutive bits in accordance with the compression rule to form a compressed section; and
recording a parameter corresponding to the compression rule in a data format,
wherein the parameter determines a length of the compressed section.

32. The method of claim 31, further comprising:
recording a first parameter (N1) corresponding to a first compression rule in the data format,
wherein the first parameter (N1) determines the number of bits required for recording the number (n1) of consecutive bits having a second binary value that follow the most significant bit having a first binary value in the section.

33. The method of claim 31, further comprising:
recording a second parameter (N2) corresponding to a second compression rule in the data format,
wherein the second parameter (N2) determines the number of bits required for recording the number (n2) of consecutive bits having a first binary value that follow the most significant bit having the first binary value in the section.

34. The method of claim 31, further comprising:
recording a third parameter (N3) corresponding to a third compression rule in the data format,
wherein the third parameter (N3) determines the number of bits required for recording the number (n3) of consecutive bits having a first binary value that follow the most significant bit having a second binary value in the section.

35. The method of claim 31, further comprising:
recording a fourth parameter (N4) corresponding to a fourth compression rule in the data format,
wherein the fourth parameter (N4) determines the number of bits required for recording the number (n4) of consecutive bits having a second binary value that follow the most significant bit having the second binary value in the section.

36. The method of claim 31, further comprising:
recording a third parameter (N3) corresponding to a third compression rule in the data format,
wherein the third parameter (N3) determines the number of bits required for recording the number (n3) of consecutive rows of bits having a second binary value that follow the most significant bit having the second binary value in the section.

37. The method of claim 31, further comprising:
recording a fourth parameter (N4) corresponding to a fourth compression rule in the data format,
wherein the fourth parameter (N4) determines the number of bits required for recording the number (n4) of consecutive bits having a second binary value that follow the most significant bit having the second binary value in a row of the section.

38. A data format capable of recording compression information for an object of a sub-picture, comprising:
a first field capable of recording a parameter corresponding to a compression rule for compressing a section of consecutive bits in a binary bit map of the object; and
a second field capable of recording a compressed section formed by compressing the section of consecutive bits in accordance with the compression rule,
wherein the parameter determines a length of the compressed section.

39. The data format of claim 38, further comprising:
a third field for specifying whether a transform of the binary bit map is performed.

40. The data format of claim 39, wherein the transform includes an exclusive-or operation performed on the binary bit map so that the number of bits having a first binary value is smaller than the number of bits having a second binary value.

41. The data format of claim 39, wherein the transform includes an inversion operation performed on the binary bit map so that the number of bits having a first binary value is smaller than the number of bits having a second binary value.

42. The data format of claim 38, further comprising:
a fourth field for specifying the color of a text portion of the object.

43. The data format of claim 38, further comprising:
a first sub-field of the first field capable of recording a first parameter (N1) corresponding to a first compression rule,
wherein the first parameter (N1) determines the number of bits required for recording the number (n1) of consecutive bits having a second binary value that follow the most significant bit having a first binary value in the section.

44. The data format of claim 38, further comprising:
a second sub-field of the first field capable of recording a second parameter (N2) corresponding to a second compression rule,
wherein the second parameter (N2) determines the number of bits required for recording the number (n2) of consecutive bits having a first binary value that follow the most significant bit having the first binary value in the section.

45. The data format of claim 38, further comprising:
a third sub-field of the first field capable of recording a second parameter (N3) corresponding to a third compression rule,
wherein the third parameter (N3) determines the number of bits required for recording the number (n3) of consecutive bits having a first binary value that follow the most significant bit having a second binary value in the section.

46. The data format of claim 38, further comprising:
a fourth sub-field of the first field capable of recording a fourth parameter (N4) corresponding to a fourth compression rule,
wherein the fourth parameter (N4) determines the number of bits required for recording the number (n4) of consecutive bits having a second binary value that follow the most significant bit having the second binary value in the section.

47. The data format of claim 38, further comprising:
a third sub-field of the first field capable of recording a third parameter (N3) corresponding to a third compression rule,
wherein the third parameter (N3) determines the number of bits required for recording the number (n3) of consecutive rows of bits having a second binary value that follow the most significant bit having the second binary value in the section.

48. The data format of claim 38, further comprising:
a fourth sub-field of the first field capable of recording a fourth parameter (N4) corresponding to a fourth compression rule,
wherein the fourth parameter (N4) determines the number of bits required for recording the number (n4) of consecutive bits having a second binary value that follow the most significant bit having the second binary value in a row of the section.
